(19) United States
(12) Patent Application Publication
(10) Pub. No.: US 2015/0248909 A1
(43) Pub. Date: Sep. 3, 2015

(54) STRUCTURE WITH SEED LAYER FOR CONTROLLING GRAIN GROWTH AND CRYSTALLOGRAPHIC ORIENTATION

(71) Applicant: HGST Netherlands B.V., Amsterdam (NL)

(72) Inventors: Bruce A. Gurney, San Jose, CA (US); En Yang, Los Altos, CA (US); Qing Zhu, San Jose, CA (US)

(73) Assignee: HGST Netherlands B.V., Amsterdam (NL)

(21) Appl. No.: 14/194,505

(22) Filed: Feb. 28, 2014

(51) Int. Cl. G11B 5/73; G11B 5/64; G11B 5/84; G11B 5/48; G11B 5/85; G11B 5/851

(52) U.S. Cl. CPC G11B 5/732; G11B 5/85; G11B 5/851; G11B 5/8404; G11B 5/48; G11B 5/645

(57) ABSTRACT

According to one embodiment, a structure includes a substrate; an epitaxial seed layer positioned above the substrate, the epitaxial seed layer including a plurality of nucleation regions and a plurality of non-nucleation regions; and a crystalline layer positioned above the epitaxial seed layer, where the epitaxial seed layer has a crystallographic orientation substantially along an axis perpendicular to an upper surface of the substrate.

### FIELD OF THE INVENTION

The present invention relates to data storage systems, and more particularly, this invention relates to a structure having a seed layer for controlling grain growth and crystallographic orientation of overlying layers, where the structure is particularly useful for magnetic recording media.

### BACKGROUND

Epitaxial growth of thin films is important to many modern technologies. Thin films formed via epitaxial growth and with preferred crystallographic orientations are particular useful in microelectronic devices, semiconductor electronics, optoelectronics, solar cells, sensors, memories, capacitors, detectors, recording media, etc. Therefore, there is a continuing need for improved epitaxial films with preferred crystallographic orientations, as well as methods of making the same.

### SUMMARY

According to one embodiment, a structure includes a substrate; an epitaxial seed layer positioned above the substrate, the epitaxial seed layer including a plurality of nucleation regions and a plurality of non-nucleation regions; and a crystalline layer positioned above the epitaxial seed layer, where the epitaxial seed layer has a crystallographic orientation substantially along an axis perpendicular to an upper surface of the substrate.

According to another embodiment, a method includes providing a substrate; forming an epitaxial seed layer above the substrate: defining a plurality of nucleation regions and a plurality of non-nucleation regions in the epitaxial seed layer; and forming a crystalline layer above epitaxial seed layer, where the epitaxial seed layer has a crystallographic orientation substantially along an axis perpendicular to an upper surface of the substrate.

Any of these embodiments may be implemented in a magnetic data storage system such as a disk drive system, which may include a magnetic head, a drive mechanism for passing a magnetic medium (e.g., hard disk) over the magnetic head, and a controller electrically coupled to the magnetic head.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIGS. 1A-1C are flowcharts of a method for forming a structure having a structured epitaxial seed layer, according to various embodiments.

FIG. 2 is a flowchart of a method for forming a structured epitaxial seed layer, according to one embodiment.

FIG. 3 is a schematic of a structure with a seed layer for controlling grain growth and crystallographic orientation of overlying layers, according to one embodiment.

FIG. 4 is a simplified drawing of a magnetic recording disk drive system, according to one embodiment.

FIG. 5 is a scanning electron microscope (SEM) image of a Pt/NiW/Ru(Magnetic layer with oxide) film stack deposited on a hexagonal array of Pt(111) seed pillars.

FIG. 6 is a transmission electron microscope (TEM) image showing registry between the columnar growth of a Pt/NiW/Ru/(Magnetic layer with oxide) film stack and Pt(111) seed pillars.

FIG. 7 is an X-ray diffraction pattern of a Pt/NiW/Ru/(Magnetic layer with oxide) film stack deposited on a hexagonal array of Pt(111) seed pillars.

FIG. 8 is a TEM image of the Pt/NiW/Ru/(Magnetic layer with oxide) film stack grown on the Pt(111) seed pillars, showing the continuity of lattice planes from the Pt to the CoCrPt magnetic layers.

FIG. 9 is a high resolution TEM image of the Pt/NiW/Ru/(Magnetic layer with oxide) film stack grown on the Pt(111) seed pillars, showing the epitaxial alignment of lattice planes from the Pt to the NiW to the Ru layers.

FIGS. 10A-10B are SEM images of nucleation regions arranged in a hexagonal configuration before and after deposition of a healing layer, respectively.

FIGS. 11A-11B are SEM images of nucleation regions arranged in a rectangular configuration before and after deposition of a healing layer, respectively.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm.

The following description discloses several preferred embodiments of disk-based storage systems and/or related systems and methods, as well as operation and/or component parts thereof. This invention particularly relates to a structure having a seed layer for controlling grain growth and crystallographic orientation of overlying layers, where the structure may be useful for magnetic recording media and other devices (e.g. microelectronics, semiconductors electronics, optoelectronics, memories, solar cells, capacitors, detectors, sensors, etc.).

In one general embodiment, a structure includes a substrate; an epitaxial seed layer positioned above the substrate, the epitaxial seed layer including a plurality of nucleation regions and a plurality of non-nucleation regions; and a crystalline layer positioned above the epitaxial seed layer, where the epitaxial seed layer has a crystallographic orientation substantially along an axis perpendicular to an upper surface of the substrate.

In another general embodiment, a method includes providing a substrate; forming an epitaxial seed layer above the substrate; defining a plurality of nucleation regions and a plurality of non-nucleation regions in the epitaxial seed layer; and forming a crystalline layer above epitaxial seed layer, where the epitaxial seed layer has a crystallographic orientation substantially along an axis perpendicular to an upper surface of the substrate.

To control growth of thin films often a seed layer is used which includes nucleation sites to direct the growth of the film. The location of the nucleation sites in the seed layer is typically determined by the statistical nature of the growth of the seed layer on a substrate. Accordingly, growth of film at these nucleation sites may be lead to undesirable properties which are the outcomes of the random or nearly random location of nucleation sites. For example, growth of crystalline grains at such nucleation sites may result in: (1) a wide distribution of the center-to-center spacing (i.e. the pitch) of the grains; (2) a wide distribution of grain sizes; and (3) increased roughness of the grain boundaries.

One approach to control the distribution in grain size and/or location, and thus prevent and/or mitigate these undesirable outcomes, may involve intentionally/purposefully locating the nucleation sites in the seed layer. In particular, this can lead to the purposeful location of columnar structures. This approach, also referred to as templated growth, may allow for better uniformity in grain pitch and/or grain size, better control over grain-to-grain exchange coupling, etc.

However, merely placing nucleation sites at specific locations in a seed layer may not result in precise crystallographic orientation of the crystalline layers formed thereon. The degree of crystallographic orientation in a sample (e.g., a magnetic recording layer) may be measured by an x-ray diffraction rocking curve, which provides the range of angles for which the crystalline film will reflect a given wavelength. X-ray diffraction (XRD) typically involves irradiating a crystalline sample with monochromatic x-ray radiation, and detecting the diffracted x-rays. To generate a XRD rocking curve, the x-ray source and detector is generally set at a specific Bragg angle (i.e. an angle at which constructive interference occurs) and the sample tilted relative thereto. The rocking curve thus serves as a measurement of the diffracted x-ray intensity versus incident angle (the angle between the x-ray source and the sample). The rocking curve width corresponds to the full width hall maximum (FWHM) of the curve, with the maximum reflecting the maximum x-ray intensity at the selected Bragg angle. Narrow rocking curve widths correspond to crystalline samples having parallel or substantially parallel lattice planes (e.g., films with a narrow distribution of crystallographic orientation). However, defects such as dislocations, curvature, stacking faults or other similar disruptions in the parallelism of the lattice planes will result in a broadening of the rocking curve width.

Narrow rocking curve widths may be desired and advantageous for a variety of applications. For instance, precise crystallographic orientation in magnetic recording layers is needed to obtain narrow switching field distributions, higher coercivity, a reduction in media noise and other magnetic properties required for high density recording. One way to achieve narrow rocking angle is through epitaxial growth. Epitaxial growth refers to the growth of a film on a crystalline layer (also referred to as a seed layer, or an epitaxial seed layer, in which the atomic arrangement of atoms is continued so that crystallinity and crystallographic direction are maintained.

Accordingly, embodiments disclosed herein describe structures having an epitaxial seed layer for controlling grain growth/location and crystallographic orientation of materials deposited thereon. In preferred approaches, growth of the deposited materials may be nucleated by the nucleation regions in the epitaxial seed layer via shadow growth, differences in local free energy between the nucleation and non-nucleation regions in the epitaxial seed layer (chemical contrast), or other such means so that individual grains of the deposited materials or islands thereof are in registry with the locations of the nucleation regions. The nucleation regions themselves may consist of a material of high crystallographic order that has a specific axis oriented along an axis perpendicular to the upper/top surface of the epitaxial seed layer, forming a local surface that has an approximately epitaxial relationship with the materials deposited thereon. The deposited material may thus have grains or islands in registry with the nucleation regions of the epitaxial seed layer, as well as have a high degree of crystallographic orientation (e.g., as measured by a rocking angle of less than 6 degrees).

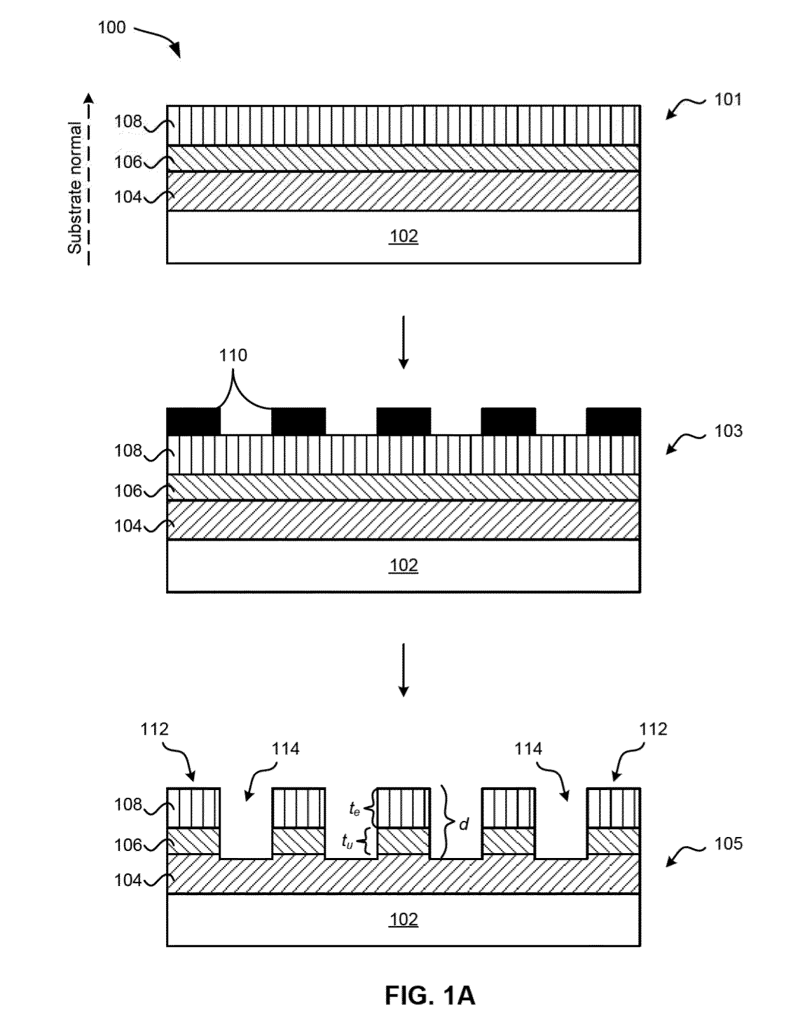

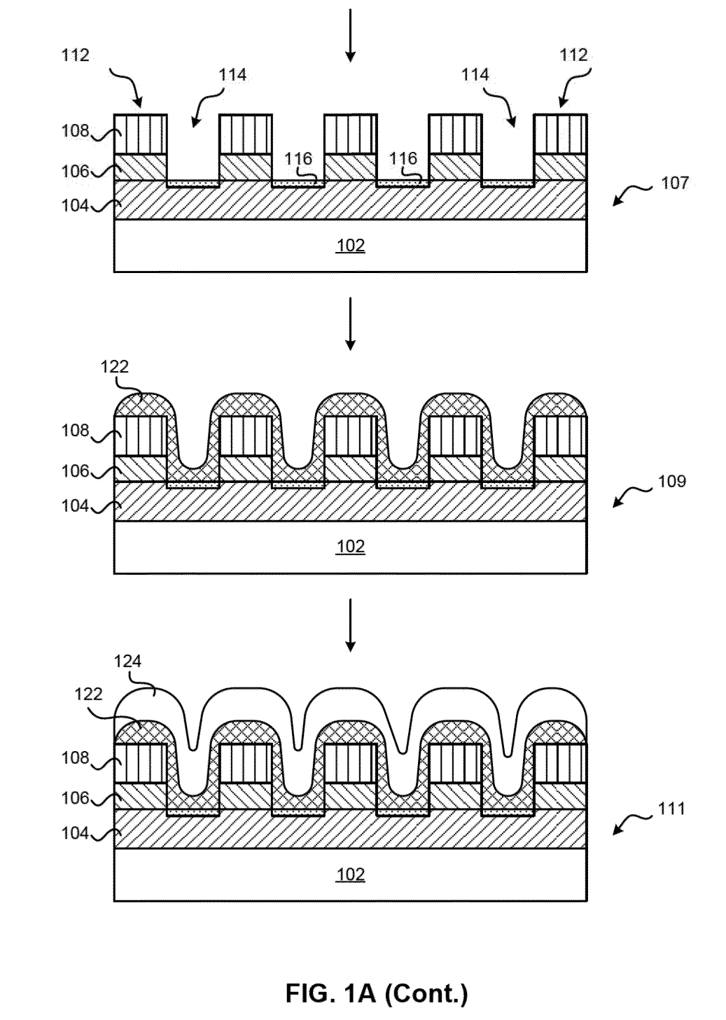

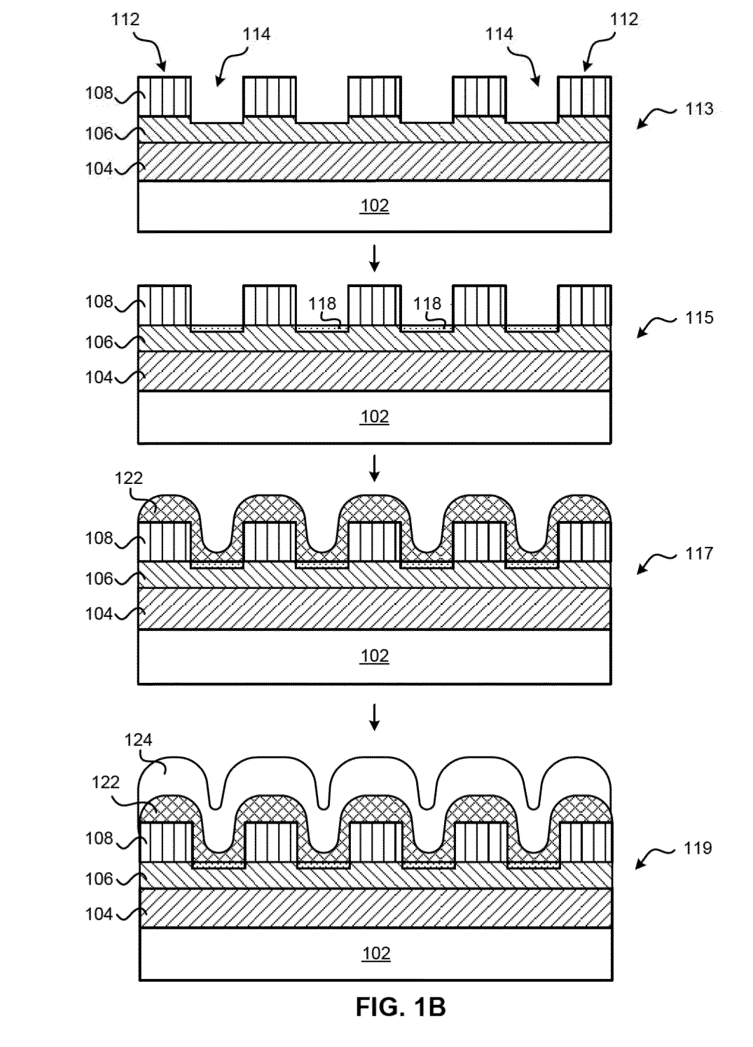

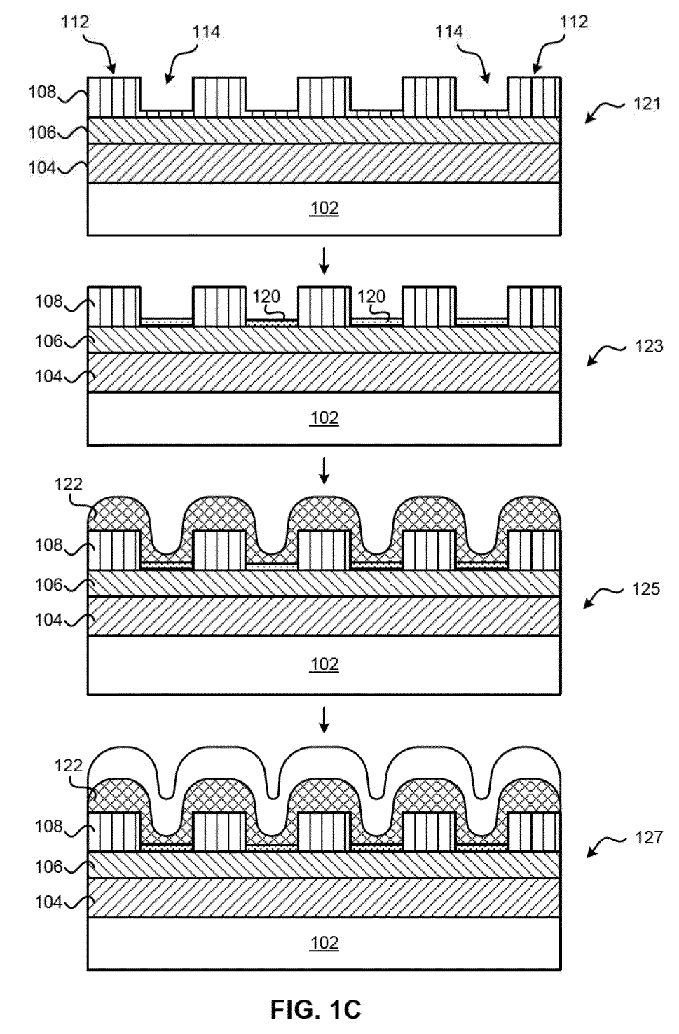

Referring now to FIGS. 1A-1C, a method 100 for forming a structure having an epitaxial seed layer is shown according to one embodiment. As an option, the present method 100 may be implemented in conjunction with features from any other embodiment listed herein, such as those described with reference to the other FIGS. Of course, this method 100 and others presented herein may be used to form structures for a wide variety of devices and/or purposes which may or may not be related to magnetic recording. It should be noted that the method 100 may include more or less steps than those described and/or illustrated in FIG. 1A-1C, according to various embodiments. It should also be noted that that the method 100 may be carried out in any desired environment. For example, some or all of steps associated with the method 100 may be carried out under vacuum (e.g. in a vacuum reaction chamber). Further, while exemplary processing techniques (e.g. deposition techniques, etching techniques, polishing techniques, etc.) are presented, other known processing techniques may be used for various steps.

As shown in FIG. 1A, the method 100 includes providing a substrate 102, forming first and second underlayers (104 and 106, respectively) above the substrate 102, and forming an epitaxial seed layer 108 above the first and second underlayers (104, 106). See structure 101.

Substrate

In various approaches, the substrate 102 may include glass, ceramic materials, glass/ceramic mixtures, AlMg, silicon, silicon-carbide, etc. In particular approaches, the substrate 102 may be any substrate suitable for use in magnetic recording media.

Underlayers

In some approaches, the first underlayer 104 and the second underlayer 106 may each include one or more materials. In more approaches, at least one, some, or all of the material(s) present in the first underlayer 104 may be the same or different from the material(s) present in the second underlayer 106. In preferred approaches, at least one of the first and second underlayers 104, 106 may include a material susceptible to oxidization (e.g., a material that easily oxidizes in an oxygen-containing atmosphere). In yet more approaches, the first underlayer 104 and/or the second underlayer 106 may include an amorphous material. In still more approaches, an upper surface of the first underlayer 104 and/or the second underlayer 106 may be smooth and/or flat, such that the upper surface thereof extends substantially along a plane that is orthogonal to the surface normal). In further approaches, the first underlayer 104 and/or the second underlayer 106 may include at least one of NiTa and NiW.

The first underlayer 104 and/or the second underlayer 106 may be deposited above the substrate via sputter deposition, ion beam deposition, chemical vapor deposition, evaporation processes, or other such techniques as would be understood by one having skill in the art upon reading the present disclosure.

Epitaxial Seed Layer

In various approaches, the epitaxial seed layer 108 may include a material selected from a group consisting of: Pt, Pd, Au, Ru, Ir, Rh, RuAl, RuRh, NiW, MgO, Cr, TiN, and combinations thereof. In particular approaches, the epitaxial seed layer 108 may include a material that is anticorrosive, e.g. a material that does not oxidize, and/or is chemically inert, e.g., is not chemically reactive.

In more approaches, the epitaxial seed layer 108 may have a physical characteristic of having a desired and specific crystal orientation. In numerous approaches, the presence of appropriate underlayers, deposition parameters (e.g. deposition technique, temperature, deposition energy, etc.) may facilitate/encourage the desired crystal orientation of the epitaxial seed layer 108. In preferred approaches, the crystals (or grains) in the epitaxial seed layer 108 may have a crystallographic orientation substantially along the axis perpendicular to the upper surface of the substrate. The axis perpendicular to the supper surface of the substrate 102 is represented by the dotted arrow shown in structure 101 of FIG. 1A, and may also be referred to as the substrate normal.

In one particular embodiment, the epitaxial seed layer 108 may include a predominantly face centered cubic (111) crystallographic texture. In another embodiment, the epitaxial seed layer 108 may include a predominantly (002) crystallographic texture. In various approaches, the crystallographic texture of the epitaxial seed layer 108 may encourage the epitaxial growth and crystallographic texture of any additional layers deposited thereon. For example, a (111) crystallographic texture of the epitaxial seed layer 108 may encourage the growth of additional NiAl(110), Ru(002), and/or CoCrPt(002) layers. Moreover, a (002) crystallographic texture of the epitaxial seed layer 108 (e.g. MgO(002)) may encourage the growth of an additional FePt L1₀(001) layer. Accordingly, in more approaches, the epitaxial seed layer 108 material(s) and the crystallographic texture/orientation thereof may be selected to encourage the growth and desired crystallographic textures/orientations (e.g., textures/orientations with the right lattice matching) of additional layers formed thereon.

The epitaxial seed layer 108 may be deposited above the second underlayer 106 via sputter deposition, ion beam deposition, chemical vapor deposition, evaporation processes, or other such techniques as would be understood by one having skill in the art upon reading the present disclosure. In additional approaches, the epitaxial seed layer 108 may be deposited at elevated/high deposition temperatures between 150 C and 800 C to improve the formation/growth and/or crystallographic orientation of the epitaxial seed layer 108.

Topographic Contrast

As additionally shown in FIG. 1A, the method 100 includes applying a mask 110 to the epitaxial seed layer 108. See structure 103. In some approaches, the mask be a stencil mask of resist, carbon, or other material suitable for lithographic pattern transfer.

With continued reference to FIG. 1A, the method 100 further includes etching the epitaxial seed layer 108 to define a plurality of nucleation regions 112 and a plurality of non-nucleation regions 114 in the epitaxial seed layer 108, thus forming a structured epitaxial seed layer 108. See structure 105. Etching the epitaxial seed layer 108 may include dry etching by high density plasma (e.g. ion milling, reactive ion etching (RIE), deep RIE, etc.), wet etching or other suitable etching techniques known in the art. In various approaches, selection of the appropriate etching process may depend upon the materials to be etched. For example, an anisotropic etch may be used to create a deep etch with steep sided vertical walls in at least the epitaxial seed layer 108, as shown in FIG. 1A. After the etch process, the mask 110 may be removed by any suitable removal process known in the art.

As a result of the etching, the non-nucleation regions 114 will be recessed relative to the nucleation regions 112, thereby providing a topographic contrast in the structured epitaxial seed layer 108. In the embodiment shown in FIG. 1A, the etching may be terminated within the first underlayer 104. See e.g. structure 105. Accordingly, in such an approach, a depth, d, of the recessed non-nucleation regions 114 may be greater than the sum of the thickness, tₑ, of the epitaxial seed layer 108 and a thickness, tᵤ, of the second underlayer 106.

In another embodiment, the etching may be terminated within the second underlayer 106, as shown in structure 113 of FIG. 1B. Accordingly, in such an embodiment, the depth, d, of the recessed non-nucleation regions 114 may be greater than the thickness of the epitaxial seed layer 108, yet less than or equal to the combined thickness of the epitaxial seed layer 108 and the second underlayer 106.

In yet another embodiment, the etching may be terminated within the epitaxial seed layer 108, as shown in structure 121 of FIG. 1C. Thus, a depth, d, of the recessed non-nucleation regions 114 may be about equal to or less than a thickness of the epitaxial seed layer 108, in such embodiments.

The topographic contrast between the nucleation regions 112 and non-nucleation regions 114 may help promote templated, epitaxial growth of additional layers deposited above the epitaxial seed layer 108. For example, topographic contrast may facilitate a shadow-growth effect where growth of these additional layers may be enhanced at the raised nucleation regions 112 and reduced in the trenches (i.e. the recessed non-nucleation regions 114).

As shown in FIGS. 1A-1C, the nucleation regions 112 may include pillar structures. Each of these pillar structures may have cross sectional shapes that include, but are not limited to, a square, a rectangle, an octagon, a hexagon, a triangle, a circle, an ellipsoid, etc., where the cross section is taken perpendicular to the substrate normal. It is important to note that the nucleation regions 112 are not limited to pillar structures, but may take the form of a mound, a mesa, a trapezoid, an irregular shape, etc. However, in preferred approaches, all or substantially all of the nucleation regions 112 may have the same form and/or cross sectional shape.

Application of the mask 110 and subsequent etching of the epitaxial seed layer 108 may allow the resulting nucleation regions 112 therein to be purposefully located. Particularly, the mask 110 may contain an array of features, where the features have a desired cross sectional shape and size and/or the array has a desired center-to-center spacing (i.e. pitch) distribution between the features. Thus, application of such a mask 110 to the epitaxial seed layer 108 and subsequently etching the exposed portions thereof, will result in the desired pattern transfer.

Accordingly, in various approaches, the structured epitaxial seed layer 108 may include an ordered arrangement of nucleation regions 112. The degree of order may be quantified by analyzing the distribution of the center-to-center spacing, i.e. the pitch (P), between the nucleation regions 112. In numerous approaches, this distribution may approximately take the form of a log normal distribution. The degree of order may be represented by: [(σ_{P})/P]*100%, where or is the full width half max value of the distribution, and P is the mean pitch value. Thus, in one embodiment, the arrangement of nucleation regions 112 in the structured epitaxial seed layer 108 may be highly ordered [i.e., (σ_{P})/P<10%)]. In other words, nucleation regions 112 may be arranged in the epitaxial seed layer 108 such that a separation between each of the nucleation regions 112 is about uniform. For example, in one approach, the nucleation regions 112 may be arranged in a hexagonally close packed (HCP) array. In another embodiment, the arrangement of nucleation regions 112 in the structured epitaxial seed layer 108 may be partially ordered [i.e., 10%<(σ_{P})/P<20%)]. In yet another embodiment, the arrangement of nucleation regions 112 in the structured epitaxial seed layer 108 may be relatively disordered [i.e., (σ_{P})/P>20%)]. In further embodiments, the center-to-center spacing between the nucleation regions 112 may be from about 2 to about 30 nm.

The degree of order associated with the arrangement of the nucleation regions 112 may be selected based on the application in which the ultimate structure formed via method 100 may be used. For instance, the arrangement of nucleation regions 112 may be selected to be partially ordered in approaches where the ultimate structure is a perpendicular recording medium. Alternatively, the arrangement of the nucleation regions 112 may be selected to be highly ordered in approaches where the ultimate structure is a patterned magnetic recording medium.

In numerous approaches, the material comprising the epitaxial seed layer 108, the etch process and ultimate etch depth may be selected to achieve a desired aspect ratio for the nucleation regions (e.g. the pillar structures) is desired for the pillar and/or based on what materials are to be exposed (and possibly oxidizes) after the etch process.

Another embodiment for forming the structured epitaxial seed layer 108 is shown in FIG. 2. As shown in FIG. 2, an optional, intermediate mask layer 202 (e.g. a carbon layer) may be deposited above the epitaxial seed layer 108. See structure 201. A mask 204 including self-assembled nanoparticles 206 dispersed in a matrix material 208 may be applied above the epitaxial seed layer 108 and/or the intermediate mask layer 202 if present. In some approaches, the nanoparticles 206 may include small (e.g. sub-100 nm) crystalline particles whose cores are composed of one or more materials including, but not limited to, FeO, FePt, CdSe, CdTe, PbSe, Si, etc. In more approaches, the matrix material 208 may include a polymer material such as polystyrene. The nanoparticles 206 may be dispersed into the matrix material 208 by several well-established techniques such as spin coating, immersion, etc.

As also shown in FIG. 2, part or all of the matrix material 208 may be removed, leaving the nanoparticles 206 to form the features of the mask 204 for pattern transfer. See structure 203. After removal of the matrix material 208, any exposed regions of the intermediate mask layer 202 and/or the epitaxial seed layer 108 may be etched to define the plurality of nucleation regions 112 and the plurality of non-nucleation region 114, thereby forming a structured epitaxial seed layer 108. See structure 205. As discussed above, the etching may terminate within the first underlayer 104, within the second underlayer 106, or within the epitaxial seed layer 108 according to various approaches. After the etching, the mask 204 and the intermediate mask layer 202 may be removed. See structure 207.

The nanoparticles 206 may be synthesized in a variety of sizes and with narrow size distributions. For instance, in some approaches, the nanoparticles 206 may be synthesized with diameters ranging from 2 to 7 nm and diameter distributions of less than 10%. The use of the small sub-100 nm nanoparticles 206 in the mask 204 for pattern transfer may allow for the formation of nucleation regions 112 with small center-to-center spacing (e.g. as low as 1 nm). However, the dispersal of the nanoparticles 206 in the matrix material 208 may give a distribution of center to center spacing (pitch) with a distribution of pitch showing some, but incomplete order, i.e. 10% o<σ_{P}/P<20%; thus application of the mask 204 for pattern transfer may result in a structured epitaxial seed layer having a partially ordered or relatively disordered arrangement of nucleation regions, in some approaches.

Yet another embodiment for forming the structured epitaxial seed layer 108 may involve application of a mask comprising self-assembling block copolymers for pattern transfer. A self-assembling block copolymer typically contains two or more different polymeric block components that are immiscible with one another. Under suitable conditions, the two or more immiscible polymeric block components separate into two or more different phases or microdomains on a nanometer scale, thereby forming ordered patterns of isolated nano-sized structural units. The two or more immiscible polymeric block components may form spherical, cylindrical, or lamellar polymeric domains, in various approaches. One of the polymeric block components may be selectively removed to leave a template with a periodic pattern of the un-removed component(s).

Chemical Contrast

Referring again to FIGS. 1A-1C. As discussed previously, one, some or all of the steps associated with the method 100 may occur under vacuum. For example, the provision of the substrate 102, formation of the first and second underlayers (104, 106) and the epitaxial seed layer 108, and etching of the epitaxial seed layer 108 may occur under vacuum. However, in some approaches, after the etching of the epitaxial seed layer 108, the resulting structure may be removed from the vacuum environment and exposed to air. Accordingly, in embodiments where the etching of the epitaxial seed layer 108 terminates within the first underlayer 104 (e.g. structure 105 of FIG. 1A), exposed regions of the first underlayer 104 may be oxidized in an oxygen containing atmosphere or process gas. An illustration of the exposed, oxidized regions 116 of the first underlayer 104 is shown in structure 107 of FIG. 1A.

It is important to note that an etching process terminating within the first underlayer 104 may also leave exposed portions of the second underlayer 106, which may also oxidize upon exposure to air in more approaches. However, in other approaches, the second underlayer 106 and/or the epitaxial seed layer 108 may contain one or more materials that do not oxidize, such that after an etching process terminating within the first underlayer 104, only exposed portions of the first underlayer 104 may oxidize upon exposure to air.

Further, in embodiments where the etching of the epitaxial seed layer 108 terminates within the second underlayer 106 (e.g. structure 113 of FIG. 1B), exposed regions of the second underlayer 106 may be oxidized in an oxygen containing atmosphere. An illustration of the exposed, oxidized regions 118 of the first underlayer is shown in structure 115 of FIG. 1B.

The oxidized regions of the first and/or second underlayers 104, 106 may have a different surface free energy than the epitaxial seed layer 108 material, thereby providing a chemical contrast between the nucleation regions 112 and the non-nucleation regions 114. This chemical contrast may cause one or more layers to preferentially (or selectively) grow over the nucleation regions 112 in the epitaxial seed layer 108, thereby generating a templating effect during said growth.

By way of example only, consider the case where the epitaxial seed layer 108 includes Pt, and the first and second underlayers (104, 106) include NiTa and NiW, respectively. Etching into the first and/or second underlayers (104, 106) will result in exposed regions of NiTa and/or NiW. After removal of the hard masks and exposure to air, these exposed regions may form TaOx and/or WOx, which will have a different surface free energy than the Pt epitaxial seed layer 108.

In further approaches, the oxidized regions of the first and/or second underlayers 104, 106 may swell, and reduce the depth of the non-nucleation regions 114 (i.e. reduce the height difference between the nucleation regions 112 and the non-nucleation regions 114). In some approaches, the swelling of the oxidized regions may eliminate the height difference between the nucleation regions 112 and the non-nucleation regions 114, such that an upper surface of the nucleation regions 112 and the non-nucleation regions 114 lie substantially along the same plane oriented perpendicular to the substrate normal. In approaches where there is no height difference between the nucleation regions 112 and the non-nucleation regions 114, growth of any layers above said regions may be dominated by chemical contrast rather than topographic contrast. However, in preferred approaches, there is a chemical contrast and a topographic contrast between the nucleation regions 112 and the non-nucleation regions 114 to promote templated growth while preserving the original, purposefully/intentionally configured nucleation regions.

Chemical contrast between the nucleation regions 112 and the non-nucleation regions 114 may also result in embodiments where the etching of the epitaxial seed layer 108 terminates within the epitaxial seed layer 108 (e.g. structure 121 of FIG. 1C). For instance, in one embodiment, the epitaxial seed layer may include a material that oxidizes when exposed to air. Accordingly, after the etching and/or optional cleaning process, all exposed regions of the epitaxial seed layer 108 may be oxidized, resulting in nucleation regions and non-nucleation regions having the same oxidized epitaxial seed layer material with the same surface free energy. However, in some approaches, the tops of the nucleation regions 112 may then be cleaned/polished (e.g., via plasma etching or other known thin film cleaning process) in a non-oxidizing atmosphere (e.g. under vacuum) to reveal non-oxidized epitaxial seed layer material, which will have a different surface free energy than the oxidized epitaxial seed layer material of the non-nucleation regions 114.

It is important to note that where etching of the epitaxial seed layer 108 terminates within the first underlayer 104 and/or the second underlayer 106, chemical contrast between the nucleation regions 112 and the non-nucleation regions 114 may still be achieved without oxidization of any exposed regions of the first and/or second underlayers 104, 106 in more approaches. For instance, such may be the case in approaches where the first and/or second underlayers 104, 106 inherently have a different surface free energy than the material(s) comprising the epitaxial seed layer 108. Additionally, whether the etching of the epitaxial seed layer 108 terminates within the epitaxial seed layer 108, the first underlayer 104 and/or the second underlayer 106, an additional material having a different surface free energy than the epitaxial seed layer material may be deposited into the non-nucleation regions 114. An illustration of an additional material 120 deposited over non-nucleation regions 114 having a depth less than the thickness of the epitaxial seed layer 108 is shown in structure 123 of FIG. 1C. In some approaches, the thickness of this additional material in the non-nucleation regions 114 may be about equal to the thickness of the nucleation regions 112, such that there is no topographic contrast therebetween. However, in preferred approaches, the thickness of the additional material in the non-nucleation regions 114 may be less than the thickness of the nucleation regions 112, such that there is both a chemical and topographic contrast therebetween.

In addition, it is also important to note that there may be no chemical contrast between the nucleation regions 112 and the non-nucleation regions 114 in some approaches. Accordingly, where there is only topographic contrast between the nucleation regions 112 and the non-nucleation regions 11, additional layers formed above the epitaxial seed layer 108 may nucleate at the purposefully/intentionally located nucleation regions 112: however, said layers may a low degree of crystallographic orientation (e.g. as measured by a rocking curve width of 6 degrees or more). In contrast, where both topographic contrast and chemical contrast are present between the nucleation regions 112 and the non-nucleation regions 114, additional layers formed above the epitaxial seed layer 108 may nucleate at the purposefully/intentionally located nucleation regions 112 and have a high degree of crystallographic orientation (e.g. as measured by a rocking curve width of less than 6 degrees).

Healing Layer

The etching of the epitaxial seed layer 108 may induce damage to a surface thereof. Thus, in one embodiment, the method 100 may optionally include a cleaning/polishing process after the etching process and/or prior to formation of any layers above the epitaxial seed layer 108. This optional cleaning/polishing process may include a plasma cleaning process, thermal process or other such suitable process as known in the art. This optional cleaning/polishing process may help reduce the defects associated with the epitaxial seed layer 108 and/or exposed regions of the underlayers (e.g. 104, 106) that are generated via the etching process. Moreover, this optional cleaning/polishing process may help remove any unwanted oxidization present on exposed surfaces of the epitaxial seed layer 108, the second underlayer 106, and/or the first underlayer 108.

In one embodiment, a healing layer 122 may be formed directly on an upper surface of the epitaxial seed layer 108 to help reduce defects associated with the epitaxial seed layer 108 and/or exposed regions of the underlayers (e.g. 104, 106) that are generated via the etching process. See structures 109, 117 and 125 of FIGS. 1A, 1B and 1C, respectively. This healing layer 122 may help improve the crystallinity of the surface to which additional layers may be formed thereon. This healing layer 122 may cover the tops of the nucleation regions 112 and fills the gaps therebetween (i.e. fills the non-nucleation regions 114). The healing layer 122 material may also nucleate over each of the nucleation regions 112 so that a thickness of the healing layer 122 may be different (e.g., preferably greater) over the nucleation regions 112 as compared to a thickness of the healing layer 122 over the non-nucleation regions 114.

The healing layer 122 may be deposited above the structured epitaxial seed layer 108 via sputter deposition, ion beam deposition, chemical vapor deposition, evaporation processes, or other such techniques as would be understood by one having skill in the art upon reading the present disclosure. In additional approaches, the healing layer 122 may be deposited at elevated/high deposition temperatures to improve the formation/growth and/or crystallographic orientation of the healing layer 122.

In some approaches, the upper surface of the epitaxial seed layer 108 may or may not be cleaned prior to the formation of the healing layer 122 directly thereon. For instance, in approaches were the exposed surfaces of the epitaxial seed layer 108 and/or the first and second underlayers 104, 106 are sufficiently clean to allow epitaxial growth, the healing layer 122 may be omitted. Alternatively, in other approaches where the entire method 100 occurs under vacuum, the method 100 may not include the optional cleaning/polishing process and/or the optional formation of the healing layer 122 directly on the upper surface of the epitaxial seed layer 108.

In some approaches, the healing layer 122 may include a material selected from a group consisting of: Pt, Pd, Au, Ru, RuAl, RuRh, NiW, MgO, Cr, TiN, Rh, Ir and combinations thereof. In particular approaches, the healing layer 122 may include a material that is anticorrosive, e.g. a material that does not oxidize.

In particular approaches, the healing layer 122 may have a physical characteristic of having a desired and specific crystal orientation. In preferred approaches, the healing layer 122 may have a crystallographic orientation substantially along the axis perpendicular to the upper surface of the substrate.

In yet more preferred approaches, the healing layer 122 comprises one or more materials that are the same and/or have the same crystallographic texture/orientation as the one or more materials of the epitaxial seed layer 108. Approaches where the healing layer 122 includes the same material(s) as the epitaxial seed layer 108 are preferable, as such a healing layer will introduce zero interface energy and help recover the nucleation regions 112 from etching damage. Despite any impurities and/or defects created by the etching process, formation of the healing layer 122 directly on the epitaxial seed layer 108, where both the healing layer 122 and the epitaxial seed layer 108 include material(s) having the same crystallographic orientation, may nonetheless result in textured growth with a narrow rocking angle (e.g. less than 6 degrees, preferably less than 3 degrees) of additional layers formed above the healing layer 122.

In various approaches, the healing layer 122 may have an appropriate or desired lattice match to any additional layers formed thereon. Thus, in preferred approaches the healing layer 122 may have a natural growth orientation that may encourage the epitaxial growth and crystallographic texture of any additional layers deposited thereon. For example, a (111) crystallographic texture of the healing layer 122 may encourage the growth of additional NiAl(110), Ru(002) and/or CoCrPt(002) layers. Moreover, a (002) crystallographic texture of the healing layer 122 may encourage the growth of an additional FePt L1₀(001) layer. Accordingly, in more approaches, the epitaxial seed layer 108 material(s) and the crystallographic texture/orientation thereof may be selected to encourage the growth and desired crystallographic textures/orientations (e.g., textures/orientations with the right lattice matching) of additional layers formed thereon.

Additional Layers

The method 100 additionally includes forming one or more additional layers 124 above the epitaxial seed layer 108 and/or the healing layer 122 if present. See structures 111, 119 and 127 of FIGS. 1A, 1B and 1C, respectively. Each of these additional layers 124 may be non-magnetic or magnetic, crystalline or non-crystalline. As a result of the topographic and/or chemical contrast between the nucleation regions 112 and the non-nucleation regions 114, the growth of the one or more additional layers 124 is initiated relative to the nucleation regions 112. Moreover, while surface topography persists, e.g. via a shadowing effect, during the growth of the one or more additional layers 124, the epitaxial alignment of the lattice planes therein may also propagate upward as the growth continues. Accordingly, the resulting one or more additional layers 124 may exhibit a high degree of crystallographic orientation (as measured by a rocking curve width measurements, e.g. of less than 6 degrees).

In various approaches, at least one of the one or more additional layers 124 may be a magnetic recording layer. As a result of the topographic and/or chemical contrast between the nucleation regions 112 and the non-nucleation regions 114, one or more magnetic grains may nucleate at the nucleation regions 112 thereby resulting in magnetic grain or island growth at desired and purposefully located locations. In addition to the registry between the nucleation regions 112 and the magnetic grains or islands, the magnetic recording layer may also have a high degree of crystallographic orientation (as measured by a rocking curve width of less than 6 degrees), where each of the magnetic grains may be oriented substantially along the substrate normal. In preferred approaches, the magnetic recording layer may have a grain pitch between about 2 nm to about 30 nm. In yet more preferred approaches, the magnetic recording layer may include a known segregant material to help isolate the magnetic grains or islands.

The one or more additional layers 124 may be deposited above the epitaxial seed layer 108 and/or the healing layer 122 via sputter deposition, ion beam deposition, chemical vapor deposition, evaporation processes, or other such techniques as would be understood by one having skill in the art upon reading the present disclosure. In additional approaches, the one or more additional layers 124 may be deposited at elevated/high deposition temperatures to improve the columnar growth and/or crystallographic orientation of said layers.

Applications/Uses

In particular approaches, the structures disclosed herein, such as those formed via method 100, may be particularly useful for magnetic recording media. Magnetic recording media has evolved since it was introduced in the 1950's. Efforts are continually being made to increase areal recording density (i.e., bit density) of the magnetic media. In order to increase the recording densities, perpendicular recording media (PMR) have been developed and found to be superior to longitudinal recording media. In PMR, the magnetization of the bits is oriented out of the film plane, whereas in longitudinal recording media, the magnetization of the bits is oriented substantially in the film plane.

Areal recording density of the magnetic media may also be increased by improving the magnetic behavior (e.g. distribution of magnetic exchange between grains) and structural distributions (e.g. grain pitch distribution) of the magnetic grains. Accordingly, one approach to improve the magnetic behavior and structural distributions of the magnetic may involve improving the shape and location of the written bit. For instance, magnetic recording media may include a seed layer comprising nucleation regions to direct the growth of the magnetic grains. Typically, magnetic grains may in conventional magnetic recording media may begin to grow at nucleation sites that are determined by the statistical nature of the growth of the seed layer on a substrate (e.g. the disk surface). Such growth may lead to several undesirable outcomes such as: (1) a wide distribution of the center-to-center spacing (i.e. the pitch) of the grains, which may lead to unwanted exchange coupling between grains in too close proximity; (2) a wide distribution of grain sizes, where grains with larger sizes are more difficult to write to and add to the write jitter, and grains with smaller sizes are more thermally unstable: and (3) increased roughness of the gain boundaries and thus the edges of the magnetic bits, further contributing to write jitter.

One way to control the distribution in grain size and/or location, and thus prevent and/or mitigate these undesirable outcomes, involves intentionally/purposefully locating the nucleation sites in the seed layer to grow columnar structures for magnetic media and to control the distribution in grain size and/or location. This approach, also referred to as templated growth, may allow for better uniformity in grain pitch and/or grain size, better control over grain-to-grain exchange coupling, etc. Examples of systems and/or related methods for intentionally/purposefully locating the nucleation sites in the seed layer may be found in U.S. Pat. No. 8,048,546, and U.S. patent application Ser. No. 13/772,110, which are both herein incorporated by reference in their entirety.

However, purposefully placing nucleation sites at specific locations in a seed layer, may not result in precise crystallographic orientation of the magnetic recording layer(s) formed thereon. Precise crystallographic orientation in magnetic recording layer, as measured by narrow rocking curve widths, is needed to obtain narrow switching field distributions, higher coercivity, a reduction in media noise and other magnetic properties required for high density recording. In preferred approaches, magnetic recording layers may have a rocking curve width of less than or equal to 3 degrees. However, magnetic recording layers containing only templated growth registry (without means of achieving precise crystallographic orientation) may have rocking curve widths of about 6 to 7 degrees.

An alternative approach to achieving higher areal density in magnetic recording media involves use of patterned recording media. In patterned recording media, the ensemble of magnetic grains that form a bit in PMR are replaced with a single island that is placed a prioiri on the disk, in a location where the write transducer expects to find the bit in order to write information and where the readback transducer expects to detect the information stored thereto. Stated another way, in patterned recording media, the magnetic recording layer on a disk is patterned into isolated magnetic regions in concentric data tracks. To reduce the magnetic moment between the isolated magnetic regions or islands in order to form the pattern, magnetic material is destroyed, removed or its magnetic moment substantially reduced or eliminated, leaving nonmagnetic regions therebetween.

There are two type of patterned magnetic recording media: discrete track media (DTM) and bit patterned media (BPM). For DTM, the isolated magnetic regions form concentric data tracks of magnetic material, where the data tracks are radially separated from one another by concentric grooves of nonmagnetic material. In BPM, the isolated magnetic regions form individual bits or data islands which are isolated from one another by nonmagnetic material. Each bit or data island in BPM includes a single magnetic domain, which may be comprised of a single magnetic grain or a few strongly coupled grains that switch magnetic states in concert as a single magnetic volume.

One approach used to generate BPM may involve depositing a full and continuous film of magnetic material (with appropriate underlayers) above a substrate, and subsequently utilizing a mask (e.g. a lithographic mask) to define the perimeters of magnetic islands via etching beyond the magnetic layers. However, it is increasingly challenging to define the magnetic islands in this way as areal density increases. An additional complications is that as island size decreases, the etch width (and therefore the etch depth) must also decrease in order to maintain a large fill factor of magnetic material in each island. This may constrain the magnetic layer(s) to smaller and smaller total thicknesses. Accordingly, there is a need for an improved means to generate magnetic islands that are purposefully located. Moreover, similar to PMR media, BPM must also achieve sufficient magnetic properties, such as a low intrinsic switching field distribution, that result from high crystallographic orientation.

Various embodiments disclosed herein describe structures for use in magnetic recording media, and methods of making the same, which achieve purposefully located magnetic islands with high crystallographic orientation, large fill factors of magnetic material in each island, well defined magnetic islands, narrow grain distributions, and desirable magnetic properties with no etching damage on the magnetic recording layer(s). In preferred embodiments, these structures may be particularly useful for patterned recording media, bit patterned magnetic recording media, and/or heat assisted magnetic recording (HAMR) media.

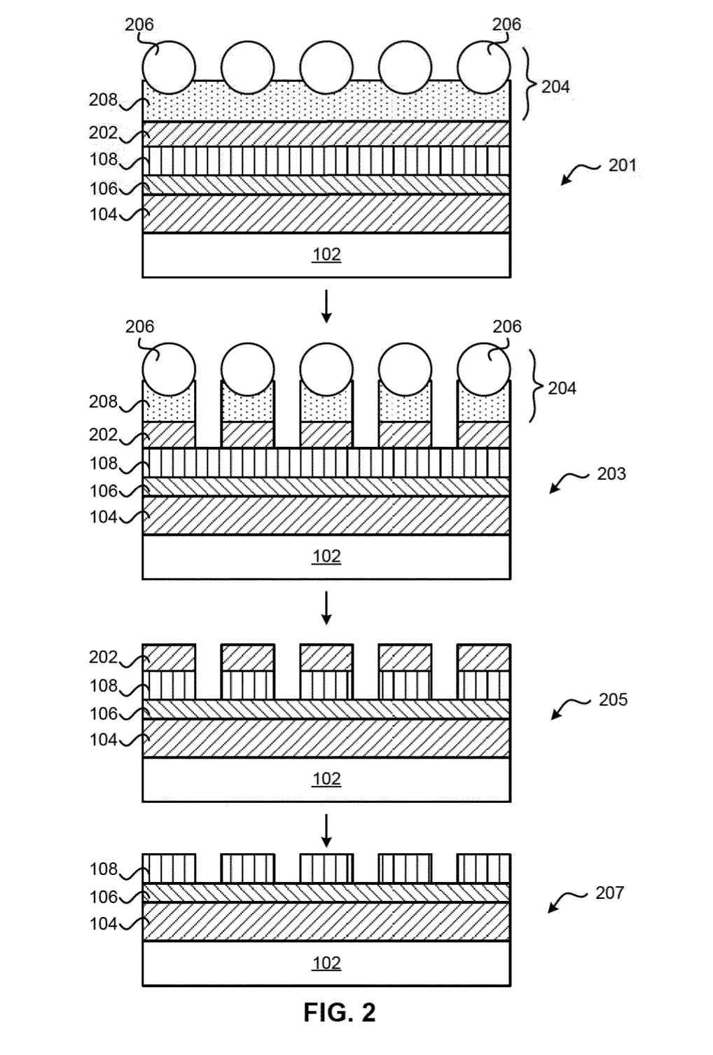

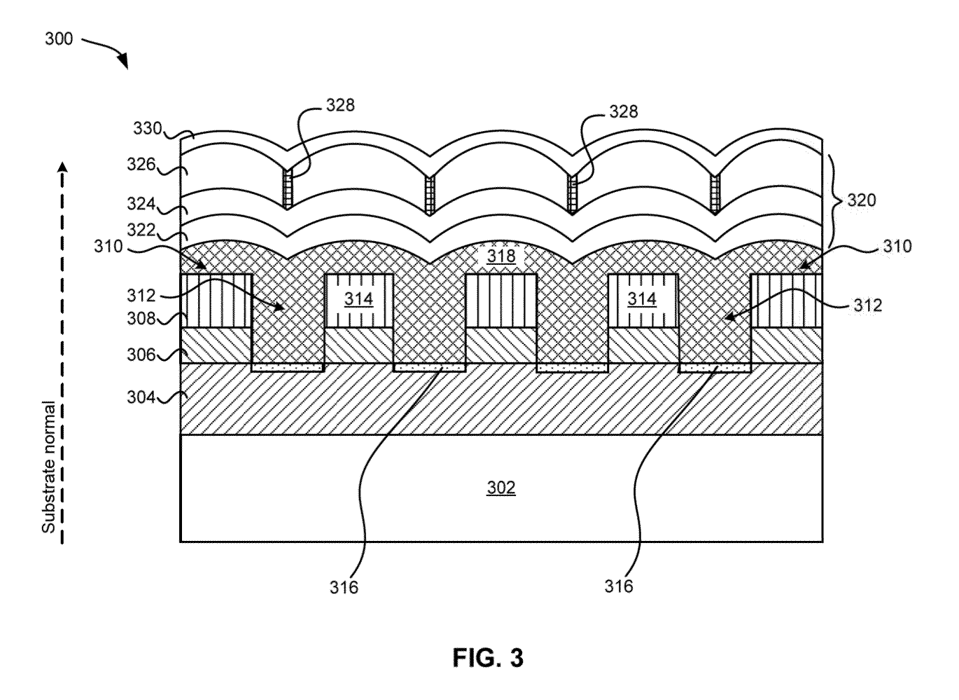

FIG. 3 illustrates a structure 300 for use as a magnetic recording medium according to one embodiment. As an option, the present structure 300 may be implemented in conjunction with features from any other embodiment listed herein, such as those described with reference to the other FIGS. Of course, the structure 300 and others presented herein may be used in various applications and/or in permutations which may or may not be specifically described in the illustrative embodiments listed herein.

As shown in FIG. 3, the structure includes a non-magnetic substrate 302, which may include glass, ceramic materials, glass/ceramic mixtures, AlMg, silicon, silicon-carbide, or other substrate material suitable for use in magnetic recording media as would be recognized by one having skill in the art upon reading the present disclosure. In one optional approach, the structure 300 may include an optional adhesion layer above the substrate 302 to promote coupling of layers formed thereabove.

As also shown in FIG. 3, the structure 300 includes a first underlayer 304 positioned above the substrate 302. A second underlayer 306 is additionally positioned above the first underlayer 304. In one approach, the first underlayer 304 and/or second underlayer 306 may include a material susceptible to oxidization (e.g., a material that easily oxidizes in an oxygen-containing atmosphere). In another approach, the first underlayer 304 and/or the second underlayer 306 may include an amorphous material. In yet another approach, the first underlayer 304 and/or the second underlayer 306 may include at least one of NiTa and NiW. In preferred approaches, an upper surface of the first underlayer 304 and/or the second underlayer 306 may be smooth and/or flat, such that the upper surface thereof extends substantially along a plane that is orthogonal to the surface normal).

The structure 300 additionally includes a structured epitaxial seed layer 308 positioned above the second underlayer 306. In some approaches, the epitaxial seed layer 108 may include a material selected from a group consisting of: Pt, Pd, Au, Ru, RuAl, RuRh, NiW, MgO, Cr, TiN, and combinations thereof. In more approaches, the epitaxial seed layer 308 may include a material that is anticorrosive, e.g. a material that does not oxidize, and/or is chemically inert, e.g., is not chemically reactive.

In additional approaches, the epitaxial seed layer 308 may have a crystallographic orientation substantially along the axis perpendicular to the upper surface of the substrate. The axis perpendicular to the supper surface of the substrate 302 is represented by the dotted arrow shown FIG. 3, and may also be referred to as the substrate normal.

In a particular approach, the epitaxial seed layer 308 may have a crystallographic texture selected and/or configured to encourage the epitaxial growth and crystallographic texture of any additional layers deposited thereon. For instance, in one embodiment, the epitaxial seed layer 308 may include a predominantly (111) crystallographic texture, which may encourage the growth of additional NiAl(110), Ru(002), and/or CoCrPt(002) layers. In another embodiment, the epitaxial seed layer 308 may include a predominantly (002) crystallographic texture, which may encourage the growth of an additional FePt L1₀0(001) layer.

As further shown in FIG. 3, the structured epitaxial seed layer 308 includes a plurality of nucleation regions 310 and a plurality of non-nucleation regions 312. The non-nucleation regions 312 are recessed relative to the nucleation regions 310, thereby providing a topographic contrast in the structured epitaxial seed layer 308. In the embodiment shown in FIG. 3, the recessed non-nucleation regions 312 may extend into the first underlayer 304 such that a depth of the recessed non-nucleation regions 312 may be greater than the thickness of the structured epitaxial seed layer 308 and a thickness of the second underlayer 106. It is important to note, however, that the in other approaches, the recessed non-nucleation regions 312 may extend only into the second underlayer 306, or may not extend past the bottom surface of the epitaxial seed layer 308 (e.g., a depth of the recessed non-nucleation regions 312 may be equal to or less than the thickness, tₑ, of the structured epitaxial seed layer 308).

The nucleation regions 310 may include pillar structures, as illustrated in FIG. 3. Each of these pillar structures may have cross sectional shapes that include, but are not limited to, a square, a rectangle, an octagon, a hexagon, a triangle, a circle, an ellipsoid, etc., where the cross section is taken perpendicular to the substrate normal. It is again important to note, however, that the nucleation regions 310 are not limited to pillar structures, but may take the form of a mound, a mesa, a trapezoid, an irregular shape, etc.

In some approaches, the structured epitaxial seed layer 308 may include a highly ordered arrangement of the nucleation regions 310. A high degree of order with respect to the arrangement of the nucleation regions 310 may be advantageous for bit patterned recording media. In other approaches, the structured epitaxial seed layer 308 may include a partially ordered arrangement of the nucleation regions 310, which may be advantageous for perpendicular recording media. In more approaches, the structured epitaxial seed layer 308 may include a relatively disordered arrangement of the nucleation regions 310.

In still more approaches, the center-to-center spacing between the nucleation regions 310 may be from about 2 to about 30 nm.

Relying on topographic contrast alone may not yield ideal or desired structures and/or properties of additional layers (e.g. a magnetic recording film stack) formed above the epitaxial seed layer 308. For instance, in approaches where the epitaxial seed layer 308 may only include topographic contrast, material deposited thereon may tend to fill in the valleys (i.e. the non-nucleation regions 312) between the protruding nucleation regions 310 to minimize the surface energy. Therefore, thick layers/films deposited on the epitaxial seed layer 308 may minimize and/or ultimately eliminate the topographic contrast. One approach to avoid this minimization and/or ultimate elimination of the topographic contrast involves depositing very thin films (e.g. films with thicknesses less than 6 nm) above the epitaxial seed layer. However, very thin films may not help the epitaxial seed layer 308 recover from the etching damage, which may introduce large grain size variation in overlying magnetic recording layers, higher rocking angles and much wider switching field distributions than is desirable for magnetic recording media.

Accordingly, in preferred approaches, the epitaxial seed layer 308 may include both topographic and chemical contrast between the nucleation regions 310 and the non-nucleation regions 312. In more preferred approaches, there may be a large interfacial surface energy between the material of the non-nucleation regions 312 and the material(s) to be deposited thereon, a small interfacial surface energy between the purposely located nucleation regions 310 and the material(s) to be deposited thereon. This encourage the epitaxial growth material deposited on the epitaxial seed layer 308 to nucleate and grow only at the nucleation regions 310. Moreover, the topographic contrast will be maintained and/or enhanced. Further, thicker film deposition above the epitaxial seed layer 308 is possible, which may minimize grain size variation, switching field distribution and rocking angle.

In other approaches, the epitaxial seed layer 308 may include only a chemical contrast. In such approaches, the chemical contrast alone may be sufficient to maintain the configuration of the nucleation regions 310. Additional layers deposited above the epitaxial seed layer 308 may nucleate at the nucleation regions 310, thereby forming columnar structures in registry with the nucleation regions 310. Thus, growth of additional layers above an epitaxial seed layer having only chemical contrast may nevertheless result in topographic contrast within the additional layers.

As additionally shown in FIG. 3, there may be a chemical contrast in addition to a topographic contrast between the nucleation regions 310 and the non-nucleation regions 312. For instance, the nucleation regions 310 may include a first material 314 and the non-nucleation regions 312 may include a second material 316, where the first and second materials have different surface free energies. In one approach, the first material 314 may be a material that does not oxidize in an oxygen-containing atmosphere, whereas the second material 316 may include an oxide. In more approaches, the second material 316 may include a nitride, an amorphous material, a metal, etc. provided that the second material has a different surface free energy than the first material.

In one specific approach, the first material 314 may be Pt, whereas the second material may be TaOx and/or WOx.

The structure 300 of FIG. 3 may also include an optional healing layer 318 positioned directly on the structured epitaxial seed layer 308. As illustrated in FIG. 3, this optional healing layer 318 may cover the nucleation regions 310 and the non-nucleation regions 312.

In one approach, the healing layer 318 may include a material selected from a group consisting of: Pt, Pd, Au, Ru, Ir, Rh, RuAl, RuRh, NiW. MgO, Cr, TiN, and combinations thereof. In particular approaches, the healing layer 318 may include a material that is anticorrosive, e.g. a material that does not oxidize. In more approaches, the healing layer may include the same material(s) as the structured epitaxial seed layer 308.

In other approaches, the healing layer 318 may have a crystallographic orientation substantially along the axis perpendicular to the upper surface of the substrate.

In particular approaches, the healing layer 318 may have a near lattice match to the structured epitaxial seed layer 308 and/or additional layers formed thereon. For example, in one approach, the healing layer 318 may have a (111) crystallographic texture, which may encourage the growth of additional NiAl(110), Ru(002), and/or CoCrPt(002) layers. Moreover, in another approach, the healing layer 318 may have a (002) crystallographic texture, which may encourage the growth of an additional FePt L1₀(001) layer. Compositionally and crystallographically oriented FePt alloy layers may be used in HAMR media.

In yet other approaches, the healing layer 318 may have a crystallographic orientation substantially along the axis perpendicular to the upper surface of the substrate.

The presence of the healing layer 318 with the same material(s) and/or crystallographic orientation as the structured epitaxial seed layer 308, may increase the rocking angle of additional layers formed above the healing layer 318 by at least 1 degree.

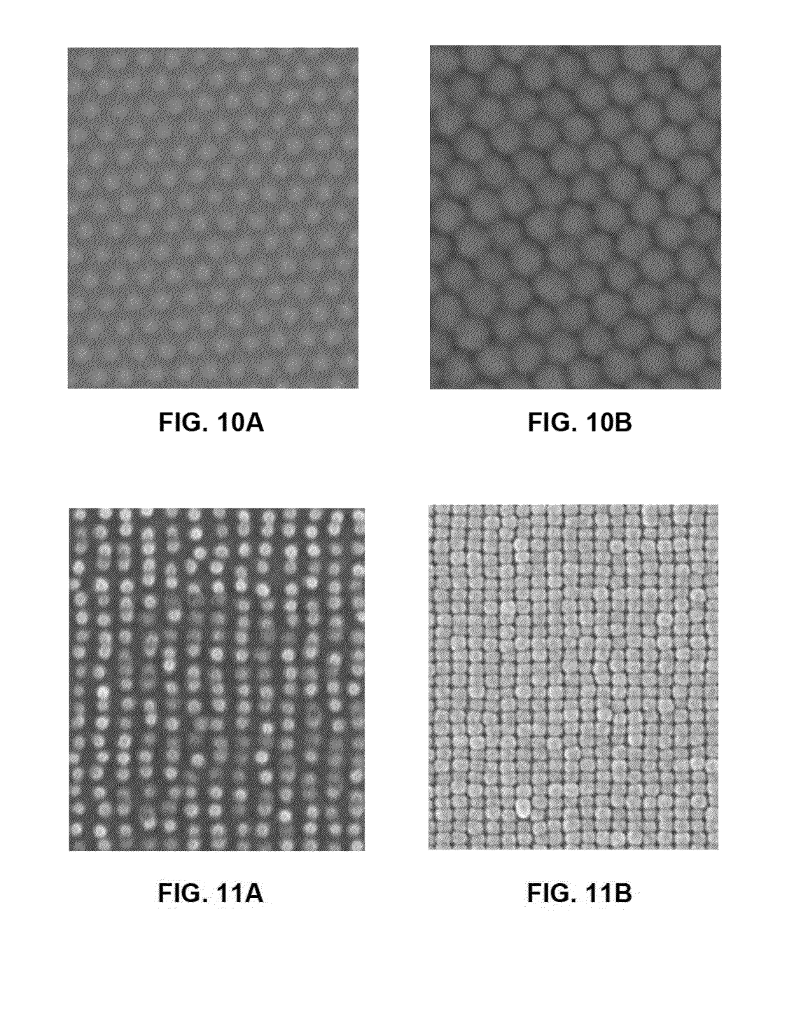

Other than reducing and/or eliminating etching/pattern transfer damage, the healing layer 318 may also minimize a switching field distribution associated with one or more magnetic recording layers deposited thereabove. In approaches where there is no healing layer, the epitaxial growth and therefore the media properties of the one or more magnetic recording layers may be limited by the size and/or shape of the nucleation regions 310. For instance, without a healing layer, the size and/or shape variation of the nucleation regions 310 in the epitaxial seed layer 308 may be maintained. However, in approaches including the healing layer 318, the nucleation regions 310 may grow and/or be altered, which may ultimately narrow the size, shape and/or pitch distributions of the final nucleation regions. Thus, the presence of the healing layer 318 may not only reduce and/or eliminate the etching damage associated with the nucleation regions 310, but may also minimize the size, shape, and/or pitch variation the nucleation regions 310. FIGS. 10A-10B illustrate the reduction in size, shape, and/or pitch variation associated with nucleation regions arranged in a hexagonal configuration after deposition of a healing layer. Likewise, FIGS. 11A-11B illustrate the reduction in size, shape, and/or pitch variation associated with nucleation regions arranged in a rectangular configuration after deposition of a healing layer.

Accordingly, in preferred approaches the structure 300 includes the healing layer 318 for templated growth. However, where there is minimal to no etching damage and/or minimal or acceptable size, shape and pitch variation between the nucleation regions 310, the healing layer 318 may be omitted in various approaches.

As shown in FIG. 3, the structure 300 includes one or more additional layers 320. In preferred approaches, the one or more additional layers form a magnetic media film stack. For example, in one approach, each of the layers 322 and 324 may independently include W, Ru, NiW, and combinations thereof. Moreover, the layer 326 may be a magnetic recording layer made of a material composed of a plurality of ferromagnetic grains. One or more magnetic grains may nucleate at each of the nucleation regions 310 thereby resulting in columnar magnetic grain or island growth at the nucleation regions 310. The magnetic recording layer 326 material may include, but is not limited to, Cr, Fe, Ta, Ni, Mo, Pt, W, Cr, Ru, Ti, Si, O, V, Nb, Ge, B, Pd. The magnetic recording material may also include alloys comprising at least two of Co, Pt, Cr, Nb, and Ta. The magnetic recording layer 326 may also be a multilayer film, for example with Co and Pd or Pt being alternately layered.

Individual magnetic grains and/or magnetic islands (e.g. comprised of a plurality of magnetic grains) may be separated by a segregant 328. As illustrated in FIG. 3, the segregant 328 is positioned above the non-nucleation regions 312. The segregant 328 may include oxides and/or nitrides of Ta, W, Nb, V, Mo, B, Si, Co, Cr, Ti, Al, etc., or C or Cr or any suitable non-magnetic segregant material known in the art.

In various approaches, the magnetic recording layer 326 may have a high degree of crystallographic orientation (as measured by a rocking curve width of less than 6 degrees), where each of the magnetic grains may be oriented substantially along the substrate normal. In preferred approaches, the magnetic recording layer 326 may exhibit a rocking curve width of less than 3 degrees.

In preferred approaches, the structure 300 may be a perpendicular recording medium, thus the direction of magnetization of the magnetic recording layer 326 will be in a direction substantially perpendicular to the recording layer surface. Moreover, the structure 300 may be also be particularly useful as a patterned magnetic recording medium (e.g. bit patterned magnetic recording medium) given the registry between the nucleation regions 310 and the magnetic grains.

As also shown in FIG. 3, the structure may include an overcoat layer 330 above the one or more additional layers 320. In preferred approaches, the overcoat layer 328 may be between approximately 1 nm and 5 nm in thickness.

In one approaches, the overcoat layer 330 may be a protective overcoat configured to protect at least the magnetic recording layer 330 from wear, corrosion, etc. This protective overcoat may be made of for example, diamond-like carbon, Si-nitride, BN or B4C, etc. or other such materials suitable for a protective overcoat as would be understood by one having skill in the art upon reading the present disclosure. The overcoat 330 is, for example, between approximately 1 nm and 5 nm in thickness.

In another approach, the overcoat layer 330 may be a capping layer configured to mediate the intergranular coupling of the magnetic grains. The capping layer may include, for example, an alloy containing Co and other materials.

In various approaches, the structure 300 may include a capping layer and a protective overcoat layer. In more approaches, a lubricant layer (not shown in FIG. 3) may also be present above the capping layer and/or the protective overcoat layer.

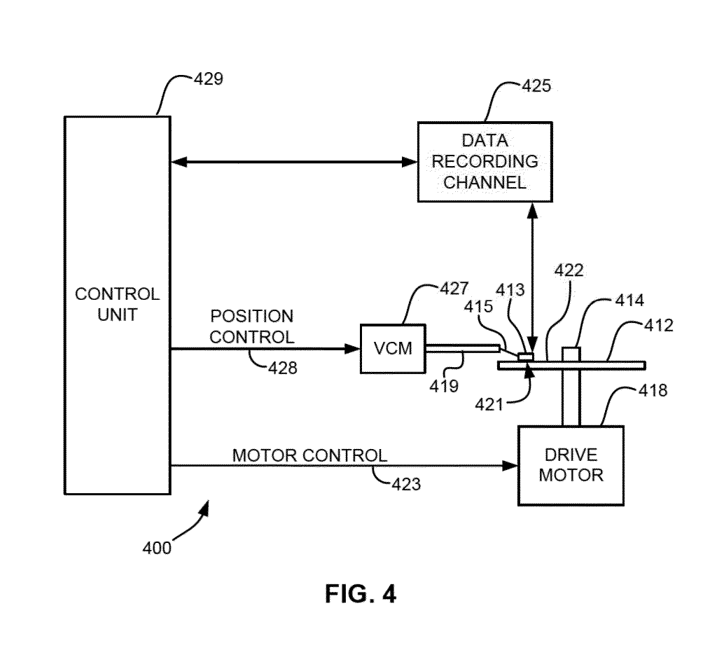

FIG. 4 shows one embodiment of a magnetic disk drive 400 that may operate with a magnetic medium, such as the structure 300 of FIG. 3. As shown in FIG. 4, at least one rotatable magnetic medium (e.g., magnetic disk) 412 is supported on a spindle 414 and rotated by a drive mechanism, which may include a disk drive motor 418. The magnetic recording on each disk is typically in the form of an annular pattern of concentric data tracks (not shown) on the disk 412. Thus, the disk drive motor 418 preferably passes the magnetic disk 412 over the magnetic read/write portions 421, described immediately below.

At least one slider 413 is positioned near the disk 412, each slider 413 supporting one or more magnetic read/write portions 421, e.g., of a magnetic head according to any of the approaches described and/or suggested herein. As the disk rotates, slider 413 is moved radially in and out over disk surface 422 so that portions 421 may access different tracks of the disk where desired data are recorded and/or to be written. Each slider 413 is attached to an actuator arm 419 by means of a suspension 415. The suspension 415 provides a slight spring force which biases slider 413 against the disk surface 422. Each actuator arm 419 is attached to an actuator 427. The actuator 427 as shown in FIG. 4 may be a voice coil motor (VCM). The VCM comprises a coil movable within a fixed magnetic field, the direction and speed of the coil movements being controlled by the motor current signals supplied by controller 429.

During operation of the disk storage system, the rotation of disk 412 generates an air bearing between slider 413 and disk surface 422 which exerts an upward force or lift on the slider. The air bearing thus counter-balances the slight spring force of suspension 415 and supports slider 413 off and slightly above the disk surface by a small, substantially constant spacing during normal operation. Note that in some embodiments, the slider 413 may slide along the disk surface 422.

The various components of the disk storage system are controlled in operation by control signals generated by controller 429, such as access control signals and internal clock signals. Typically, control unit 429 comprises logic control circuits, storage (e.g., memory), and a microprocessor. In a preferred approach, the control unit 429 is electrically coupled (e.g., via wire, cable, line, etc.) to the one or more magnetic read/write portions 421, for controlling operation thereof. The control unit 429 generates control signals to control various system operations such as drive motor control signals on line 423 and head position and seek control signals on line 428. The control signals on line 428 provide the desired current profiles to optimally move and position slider 413 to the desired data track on disk 412. Read and write signals are communicated to and from read/write portions 421 by way of recording channel 425.

The above description of a typical magnetic disk storage system, and the accompanying illustration of FIG. 4 is for representation purposes only. It should be apparent that disk storage systems may contain a large number of disks and actuators, and each actuator may support a number of sliders.

An interface may also be provided for communication between the disk drive and a host (integral or external) to send and receive the data and for controlling the operation of the disk drive and communicating the status of the disk drive to the host, all as will be understood by those of skill in the art.

In a typical head, an inductive write portion includes a coil layer embedded in one or more insulation layers (insulation stack), the insulation stack being located between first and second pole piece layers. A gap is formed between the first and second pole piece layers of the write portion by a gap layer at or near a media facing side of the head (sometimes referred to as an ABS in a disk drive). The pole piece layers may be connected at a back gap. Currents are conducted through the coil layer, which produce magnetic fields in the pole pieces. The magnetic fields fringe across the gap at the media facing side for the purpose of writing bits of magnetic field information in tracks on moving media, such as in circular tracks on a rotating magnetic disk.

The second pole piece layer has a pole tip portion which extends from the media facing side to a flare point and a yoke portion which extends from the flare point to the back gap. The flare point is where the second pole piece begins to widen (flare) to form the yoke. The placement of the flare point directly affects the magnitude of the magnetic field produced to write information on the recording medium.

It is important to note that the structures disclosed herein are not limited to magnetic recording media. Rather the structures disclosed herein, which may have seed layers with purposefully located nucleation regions and/or preferred crystallographic orientations may also be useful in microelectronic devices, semiconductor electronics, optoelectronics, solar cells, sensors, memories, capacitors, detectors, recording media, etc.

### Example

The following non-limiting example provides one embodiment of a structure for use as a magnetic recording medium, where the structure includes a seed layer for controlling grain growth and crystallographic orientation of overlying layers. It is important to note that the following example is for illustrative purposes only and does not limit the invention in anyway. It should also be understood that variations and modifications of this examples may be made by those skilled in the art without departing from the spirit and scope of the invention.

Formation of this exemplary structure included depositing a NiTa underlayer above a substrate; depositing a NiW underlayer above the NiTa underlayer; and depositing a Pt(111) seed layer above the NiTa underlayer. The Pt(111) seed layer was then etched to form a hexagonal array of Pt(111) seed pillars. Regions of the NiTa and NiW underlayers penetrated by the etching process and exposed to oxygen formed TaOx and WOx, respectively. Consequently, the texture encouraging Pt seed pillars with preferred (111) crystallographic texture were located in a matrix of TaOx and WOx. Accordingly, a template was formed including the Pt(111) seed pillars (i.e. nucleation regions) with high crystal orientation to encourage epitaxial growth and valleys/trenches therebetween (i.e. non-nucleation regions) consisting of an oxide material with a chemical contrast (e.g., a different surface free energy) to the seed pillars.

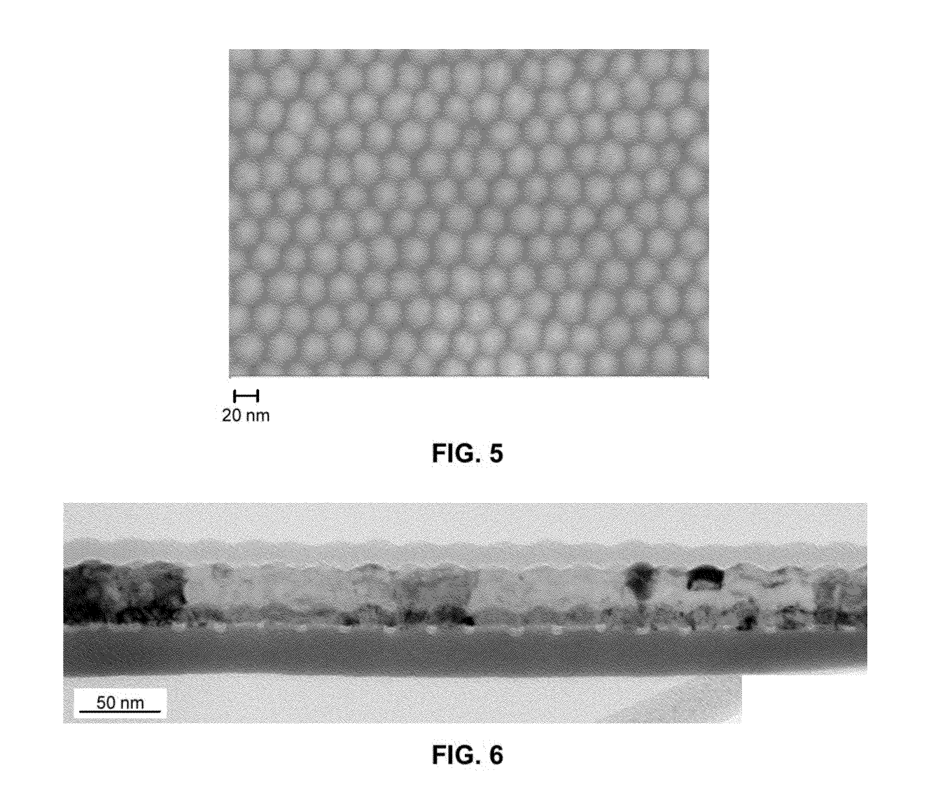

A series of layers [Pt/NiW/Ru/(Magnetic layer with oxide)] were then deposited on the template (i.e. above the Pt(111) seed pillars and non-nucleation regions). A scanning electron microscope (SEM) image of the Pt/NiW/Ru/(Magnetic layer with oxide) film stack deposited on the hexagonal array of Pt(111) seed pillars is shown in FIG. 5. The SEM image of FIG. 5 illustrates that fully deposited magnetic media islands are located at the Pt(111) seed pillars. Moreover, Polar Kerr measurements showed a large coercivity and a large (negative) nucleation field, further indicating that the magnetic media islands were isolated. Further, static tester magnetic recording measurements also indicated that these magnetic media islands were magnetically indivisible (which is required for bit patterned recording media).

The topography between the Pt(111) seed pillars and non-nucleation regions encouraged the columnar growth of the columnar structure of the Pt/NiW/Ru/(Magnetic layer with oxide) film stack due to the shadowing effect. FIG. 6 is a transmission electron microscope (TEM) image showing registry between this columnar growth and the Pt(111) seed pillars.

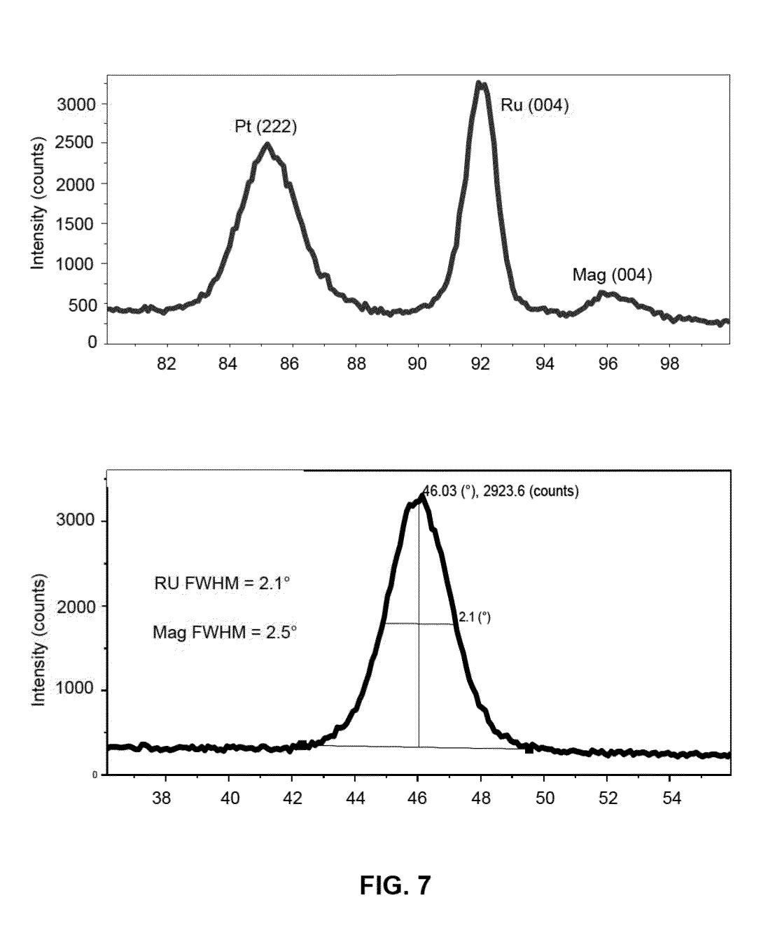

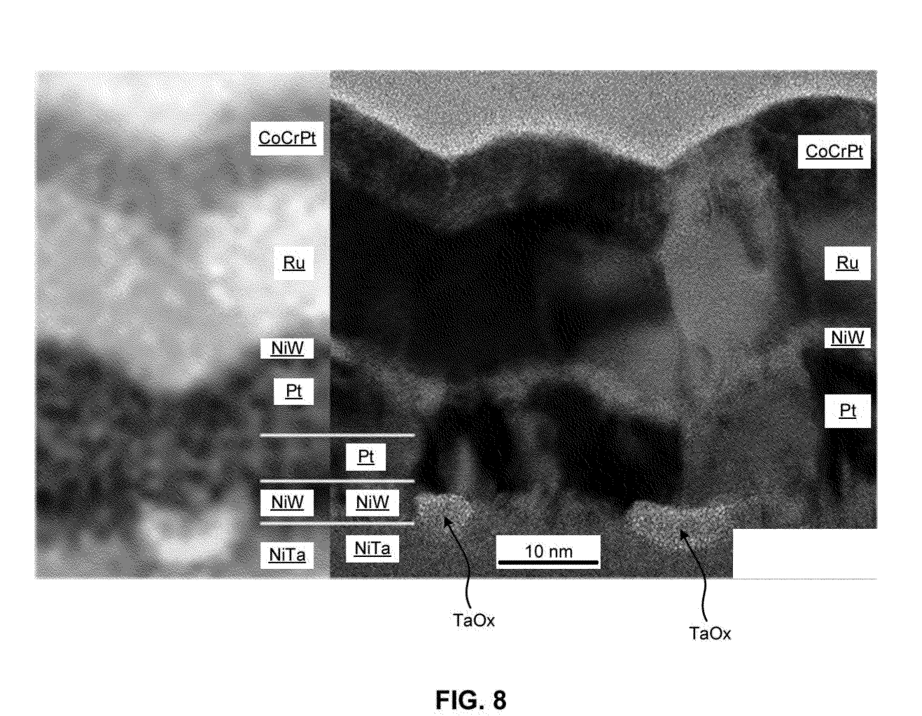

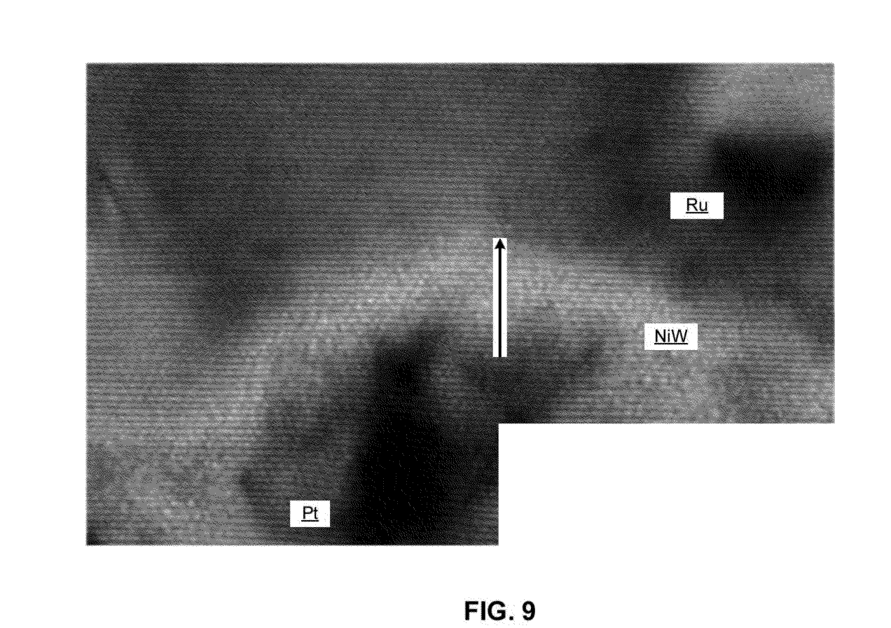

In addition, the chemical contrast between the Pt(111) seed pillars and non-nucleation regions encouraged a high degree of crystallographic orientation in Pt/NiW/Ru/(Magnetic layer with oxide) film stack. Moreover, X-ray diffraction data showed that the Pt layer deposited on top of the Pt(111) seed pillars acted as a texture healing layer, recovering enough surface order to ensure a good narrow rocking angles of subsequently deposited layers. FIG. 7 provides X-ray diffraction data associated with the Pt/NiW/Ru((Magnetic layer with oxide) film stack after template growth, excellent perpendicular texture, with a FWHM of Ru being 2.1 degree. The magnetic rocking angle is around 2.8 degree. Additionally. FIG. 8 provides a TEM image of the Pt/NiW/Ru/(Magnetic layer with oxide) film stack grown on the Pt(111) seed pillars, showing the continuity of lattice planes from the Pt to the CoCrPt magnetic layers. FIG. 9 provides another high resolution TEM image showing the epitaxial alignment of lattice planes from the Pt to the NiW to the Ru layers.

It should be noted that methodology presented herein for at least some of the various embodiments may be implemented, in whole or in part, in computer hardware, software, by hand, using specialty equipment, etc. and combinations thereof.

Moreover, any of the structures and/or steps may be implemented using known materials and/or techniques, as would become apparent to one skilled in the art upon reading the present specification.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A structure, comprising:
a substrate;
an epitaxial seed layer positioned above the substrate, the epitaxial seed layer comprising a plurality of nucleation regions and a plurality of non-nucleation regions; and
a crystalline layer positioned above the epitaxial seed layer,
wherein the epitaxial seed layer has a crystallographic orientation substantially along an axis perpendicular to an upper surface of the substrate.

2. The structure as recited in claim 1, wherein the epitaxial seed layer comprises at least one of a chemical and a topographical contrast between the nucleation and non-nucleation regions.

3. The structure as recited in claim 1, wherein the nucleation regions comprise a first material and the non-nucleation regions comprise a second material, wherein the first and second materials have different surface free energies.

4. The structure as recited in claim 3, wherein the second material comprises an oxide.

5. The structure as recited in claim 1, wherein the non-nucleation regions are recessed relative to the nucleation regions.

6. The structure as recited in claim 5, wherein a depth of the recessed non-nucleation regions is greater than a thickness of the epitaxial seed layer.

7. The structure as recited in claim 5, wherein a depth of the recessed non-nucleation regions is about equal to or less than a thickness of the epitaxial seed layer.

8. The structure as recited in claim 1, wherein the nucleation regions comprise pillar structures.

9. The structure as recited in claim 1, wherein a pitch of the non-nucleation regions is between about 2 to about 30 nm.

10. The structure as recited in claim 1, wherein the epitaxial seed layer comprises a material selected from a group consisting of: Pt, Pd, Au, Ru, RuAl, RuRh, NiW, MgO, Cr, TiN, and combinations thereof.

11. The structure as recited in claim 1, further comprising a healing layer deposited directly on an upper surface of the epitaxial seed layer.

12. The structure as recited in claim 11, wherein the healing layer has a crystallographic orientation substantially along an axis perpendicular to an upper surface of the substrate.

13. The structure as recited in claim 1, further comprising one or more underlayers positioned below the epitaxial seed layer and above the substrate.

14. The structure as recited in claim 1, wherein the epitaxial seed layer comprises a (111) crystallographic texture.

15. The structure as recited in claim 1, wherein the epitaxial seed layer comprises a (002) crystallographic texture.

16. The structure as recited in claim 1, wherein the epitaxial seed layer comprises an ordered arrangement of nucleation regions.

17. The structure as recited in claim 1, further comprising at least one of a capping layer and a protective overcoat positioned above the crystalline layer.

18. The structure as recited in claim 1, wherein the crystalline layer has a crystallographic orientation substantially along the axis perpendicular to the upper surface of the substrate.

19. The structure as recited in claim 1, wherein the crystalline layer is a magnetic recording layer.

20. The structure as recited in claim 19, wherein the magnetic recording layer comprises a magnetic material and a non-magnetic material, wherein the magnetic material is positioned above the nucleation regions in the epitaxial seed layer and the non-magnetic material is positioned above the non-nucleation regions in the epitaxial seed layer.

21. A magnetic data storage system, comprising:
at least one magnetic head,
the structure as recited in claim 20;
a drive mechanism for passing the structure over the at least one magnetic head; and
a controller electrically coupled to the at least one magnetic head for controlling operation of the at least one magnetic head.

22. A method for forming the structure of claim 1, the method comprising:
providing the substrate;
forming the epitaxial seed layer above the substrate;
defining the plurality of nucleation regions and the plurality of non-nucleation regions in the epitaxial seed layer; and
forming the crystalline layer above epitaxial seed layer.

23. The method as recited in claim 22, wherein defining the plurality of nucleation regions and the plurality of non-nucleation regions in the epitaxial seed layer comprises forming at least one of a chemical and a topographical contrast between the nucleation and non-nucleation regions.

24. The method as recited in claim 23, wherein forming the topographical contrast between the nucleation and non-nucleation regions comprises:
providing a mask layer above the epitaxial seed layer, and
removing exposed regions of the epitaxial seed layer.
